(19) United States
(12) Patent Application Publication
(10) Pub. No.: US 2013/0325512 A1
(43) Pub. Date: Dec. 5, 2013

(54) ELECTRONIC MEDICAL RECORD SYSTEM AND METHOD OF PROVIDING SERVICE THEREOF

(71) Applicant: Samsung Electronics Co., Ltd, Gyeonggi-do (KR)

(72) Inventors: Jaeho Kim, Hwaseong-si (KR); Hyoungjoon Park, Yongin-si (KR); Seunghoon Oh, Suwon-si (KR); Hyunwon Lee, Seongnam-si (KR)

(21) Appl. No.: 13/910,870

(22) Filed: Jun. 5, 2013

(30) Foreign Application Priority Data
Jun. 5, 2012 (KR) 10-2012-0060652

(51) Int. Cl. G06F 19/00

(52) U.S. Cl. CPC G06F 19/322
USPC 705/3

(57) ABSTRACT

A mobile EMR system and a method of providing a service thereof strengthen mobility and security in an existing EMR system. The method of providing a service in a mobile electronic medical record (EMR) system includes: receiving, by a mobile EMR management server, a command that requests EMR information from a mobile client; converting the command, having received from the mobile client to a command of a method in which a hospital information system (HIS) supports; forwarding an EMR information request to the HIS using the converted command; acquiring the requested EMR information from the HIS; and transmitting the acquired EMR information to the mobile client.

### CROSS-REFERENCE TO RELATED APPLICATION(S) AND CLAIM OF PRIORITY

The present application is related to and claims the benefit under 35 U.S.C. §119(a) of a Korean patent application filed on Jun. 5, 2012 in the Korean Intellectual Property Office and assigned Serial No. 10-2012-0060652, the entire disclosure of which is hereby incorporated by reference.

### TECHNICAL FIELD

The present disclosure relates to an electronic medical record system (EMR), and more particularly, to a mobile EMR system and a method of providing a service thereof that strengthen mobility and security in an existing EMR system.

### BACKGROUND

Due to development of information and communication technology, a computer-based patient record is widely used even in the medical treatment field. Particularly, nowadays, due to the progress toward an information-oriented society, an EMR system has been rapidly introduced. The EMR system upgrades paper medical records through computerization without changing a business processing structure or information range, and information contents. Therefore, the EMR system embodies a system that inputs, arranges, and stores medical treatment and surgical operation records generated in a patient's medical treatment through computerization.

The EMR system reduces writing within a medical institution by computerizing a patient's entire information generated while performing a medical treatment and causes decrease of a patient's standby time, convenience of information storage, easy access of medical personnel to a patient record, various uses of information, and cost reduction beyond simple conversion of a form. Main contents of the EMR system can include a patient's basic information, medical history, drug reaction, health state, medical test record, and record of entrance into and leaving from a hospital, radiation treatment and imaging result, and other auxiliary research result.

Such an EMR system is generally used within a hospital and uses EMR information constructed at an EMR system using a personal computer (PC) fixed to a specific location. However, because an existing PC-based EMR system has a restriction in mobility, when visiting inpatients of a hospital for a visit medical treatment, it is very difficult to use the existing PC-based EMR system in real time. Further, as hospitals use different EMR systems, each hospital has difficulty in constructing an EMR system, and even if the EMR system has the same or similar function, users experience inconvenience when using different hospitals or different EMR systems. Therefore, a method for a more systematic integrated medical treatment management is desirable.

### SUMMARY

To address the above-discussed deficiencies embodiments of the present disclosure provide a mobile EMR system and a method of providing a service thereof that can strengthen mobility and security.

Certain embodiments of the present disclosure include a mobile EMR system and a method of providing a service thereof that can provide convenience to a user by embodying a PC-based EMR system into a mobile client-based EMR system that can be easily carried.

Certain embodiments of the present disclosure include a mobile EMR system and a method of providing a service thereof that can solve inconvenience in use by enabling a user to use the mobile EMR system with the same use method for the same function even in different EMR system environments by embodying the mobile EMR system.

Certain embodiments of the present disclosure include a mobile EMR system and a method of providing a service thereof that enable efficient integrated medical management by providing a systematic interface between a mobile client, a mobile EMR management server, and a hospital information system (HIS) for embodying the mobile EMR system.

Certain embodiments of the present disclosure include a mobile EMR system and a method of providing a service thereof that can improve a user convenience and EMR accessibility by a mobile client by providing an optimal environment for embodying the mobile EMR system.

Certain embodiments of the present disclosure include a method of providing a service in an EMR system includes: receiving, by a mobile EMR management server, a command that requests EMR information from a mobile client; converting the command, having been received from the mobile client, to a command of a method in which a HIS supports; forwarding an EMR information request to the HIS using the converted command; acquiring the requested EMR information from the HIS; and transmitting the acquired EMR information to the mobile client.

Certain embodiments of the present disclosure include a computer readable recording medium on which a program for executing the method in a processor is recorded.

Certain embodiments of the present disclosure include a mobile EMR system that includes: a mobile client for executing a client program for an EMR information service and transmitting an EMR information request command corresponding to a user input; a mobile EMR management server for converting a command, having been received from the mobile client, to a command of an interface specification in which a HIS supports acquiring EMR information based on the converted command, and forwarding the EMR information to the mobile client; and a HIS for constructing and storing various EMR information into a database.

Certain embodiments of the present disclosure include a computer readable recording medium on which a program for providing a service of receiving a command that requests EMR information, converting the received command to a command of a method in which the HIS supports, and acquiring and providing the requested EMR information to the HIS using the converted command is recorded.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a configuration of a mobile EMR system according to embodiments of the present disclosure;

FIG. 2 illustrates a configuration of the mobile client of FIG. 1;

FIG. 3 illustrates a configuration of the mobile EMR management server of FIG. 1;

FIG. 4 illustrates a message flow diagram of a service operation of the mobile EMR system of FIG. 1;

FIG. 5 illustrates an operation of processing a command in the mobile EMR management server of FIG. 1;

FIG. 6 illustrates a support function in the mobile EMR system of FIG. 1;

FIGS. 7 to 16 illustrate a screen interface supported through the mobile EMR system of FIG. 1; and

FIG. 17 illustrates the mobile EMR system of FIG. 1.

### DETAILED DESCRIPTION

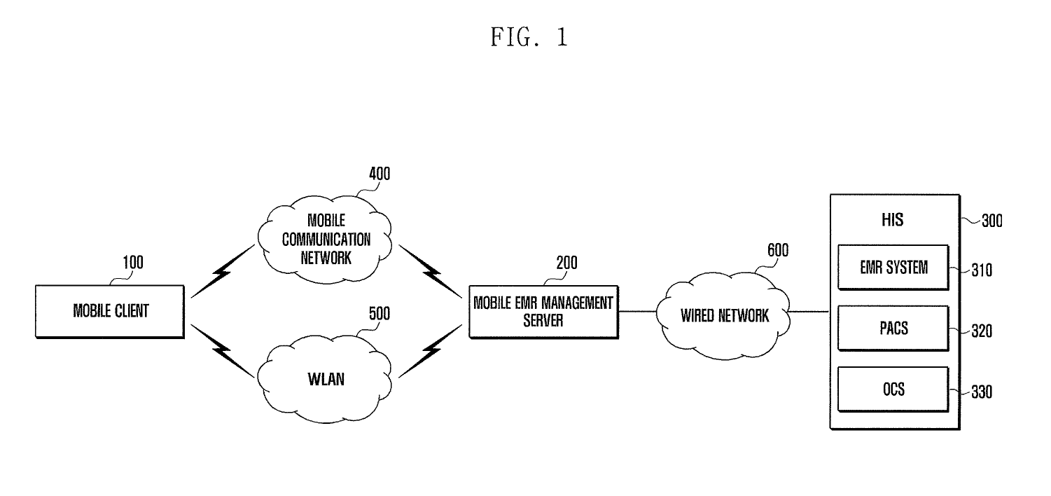

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. Hereinafter, embodiments of the present disclosure are described in detail with reference to the accompanying drawings. The same reference numbers are used throughout the drawings to refer to the same or like parts. The views in the drawings are schematic views only, and are not intended to be to scale or correctly proportioned. Detailed descriptions of known functions and structures incorporated herein may be omitted to avoid obscuring the subject matter of the present invention.

The present disclosure relates to an EMR system and a method of providing a service thereof. Particularly, embodiments of the present disclosure relate to a mobile-based EMR system and a method of providing a service thereof in which portability, mobility, and security are strengthened by overcoming an existing personal computer (PC)-based EMR system. According to embodiments of the present disclosure, in a mobile client, a client program for servicing EMR information is executed, and a request of the mobile client is forwarded to a hospital server (e.g., hospital information system (HIS)) through a mobile EMR management server, and a response of the hospital server is transmitted to the mobile client through the mobile EMR management server.

Particularly, according to embodiments of the present disclosure, by enabling an existing EMR function to separate into independent function modules and to embody only functions requested by each hospital through the mobile client: by an interlock structure between the mobile client, a mobile EMR management server, and a hospital server (HIS), a mobile EMR system can be simply constructed without replacing an existing entire EMR system constructed in the hospital. That is, the mobile client and the mobile EMR management server are independent function modules and are separated from the HIS. The mobile EMR management server enables a mobile EMR system of the present disclosure to be embodied in a form interlocked with the HIS by activating only functions allowed by the HIS.

Hereinafter, a configuration of a mobile EMR system and a method of operating and controlling the mobile EMR system according to embodiments of the present disclosure are described with reference to the accompanying drawings. A configuration of a mobile EMR system and a method of operating and controlling the mobile EMR system according to embodiments of the present disclosure are not limited by the following description and can be applied to various embodiments based on the following examples.

FIG. 1 illustrates a configuration of a mobile EMR system according to embodiments of the present disclosure.

Referring to FIG. 1, the mobile EMR system includes a mobile client 100, mobile EMR management server 200, and hospital information system (HIS) 300.

In the embodiment of FIG. 1, operation using one mobile client 100 is described, but the present invention is not limited thereto, and two or more mobile clients can search for and acquire EMR information of the HIS 300 through the mobile EMR management server 200, or can generate new EMR information in the HIS 300.

The mobile client 100 receives various EMR information recorded in the HIS 300 through the mobile EMR management server 200 and outputs the received information through a screen interface, such as a given user interface (UI) or graphic user interface (GUI). Particularly, the mobile client 100 generates a command corresponding to a user (e.g., a doctor or a nurse) input, transmits the command to the mobile EMR management server 200, and acquires and displays information corresponding to the command from the mobile EMR management server 200. The mobile client 100 connects to the mobile EMR management server 200 through a wireless network such as a mobile communication network 400 or a wireless local area network (WLAN) 500. In this case, the mobile client 100 transmits and receives data to and from the mobile EMR management server 200 through a data interface (e.g., interface that supports communication of a hyper text transfer protocol (HTTP) specification).

The mobile EMR management server 200 performs a gateway function between the mobile client 100 and the HIS 300. Particularly, the mobile EMR management server 200 receives a command that requests storage of information or a search of information from the mobile client 100. The mobile EMR management server 200 converts the command received from the mobile client 100 to a command for forwarding to the HIS 300. The mobile EMR management server 200 forwards the converted command to the HIS 300 through a wired network 600.

For example, when a command is received from the mobile client 100, the mobile EMR management server 200 determines a request (or type) of the received command and converts the determined command to a command (specification command) according to a data interface specification agreed-upon with the HIS 300. That is, the mobile EMR management server 200 converts the received command into a specification command corresponding to the received command. For example, when the mobile EMR management server 200 receives a command from the mobile client 100 that requests to provide information A, the mobile EMR management server 200 analyzes the received command, determines a request for providing the information A, converts the command to correspond to a data interface specification with the HIS 300 based on the determined content, and requests to provide the information A to the HIS 300.

Further, when a command from the mobile client 100 is received, the mobile EMR management server 200 performs authentication of the mobile client 100 and performs a processing of the command, when the mobile client 100 is an authenticated mobile client.

The HIS 300 indicates an integrated management system within a hospital including an EMR system 310, picture archiving communication system (PACS) 320, which is a picture storage and transmission system, and ordering communication system (OCS) 330, which is a prescription transfer system. The HIS 300 computerizes and stores entire information generated while performing a medical treatment. For example, the HIS 300 generates and stores various EMR information such as a patient's basic information, problem history, drug reaction, health state, medical test, and record of entrance-into/leaving from (for example, admission into and discharge from) a hospital, X-ray record, computed tomography (CT) record, magnetic resonance imaging (MRI) record, prescription record, and test record into a database (DB). The HIS 300 receives a command according to a data interface specification agreed-upon with the mobile EMR management server 200 and provides EMR information corresponding to the received command to the mobile EMR management server 200.

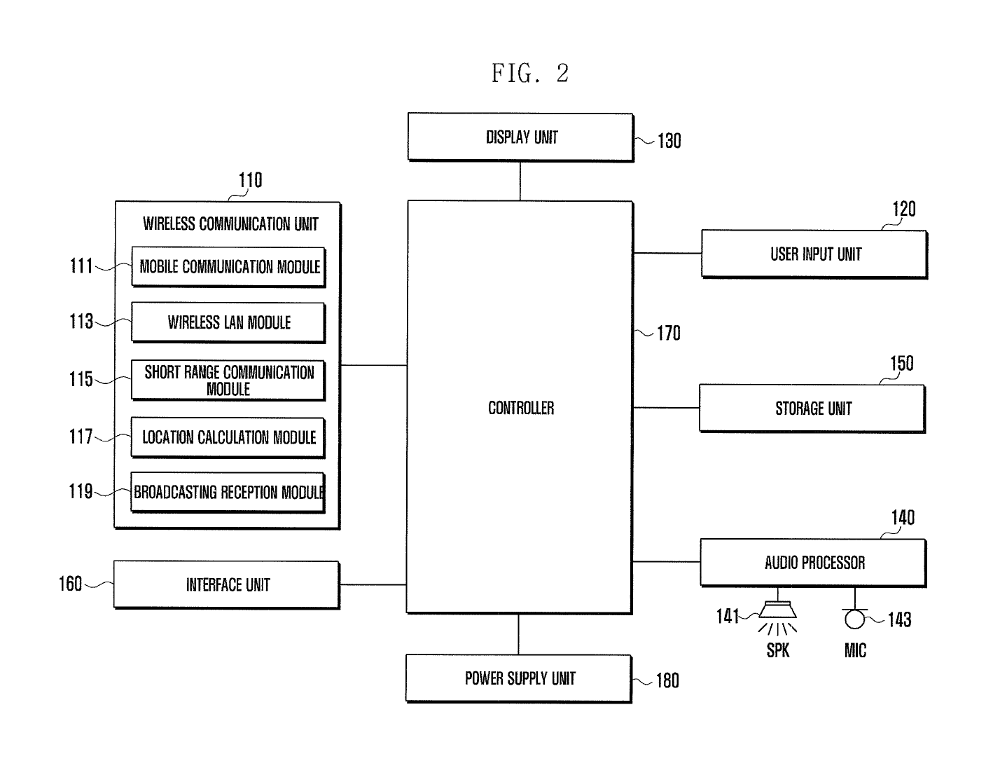

FIG. 2 illustrates a configuration of the mobile client of FIG. 1.

Referring to FIG. 2, the mobile client 100 of FIG. 1 includes a wireless communication unit 110, user input unit 120, display unit 130, audio processor 140, storage unit 150, interface unit 160, controller 170, and power supply unit 180. In the mobile client 100, constituent elements shown in FIG. 2 are not essential elements and thus the mobile client 100 can include more constituent elements or less constituent elements.

The wireless communication unit 110 can include at least one module that enables wireless communication between the mobile client 100 and a wireless communication system or between a mobile client and a network in which the mobile client is located. Particularly, the wireless communication unit 110 includes at least one module that enables wireless communication with the mobile EMR management server 200. For example, the wireless communication unit 110 includes a mobile communication module 111, wireless LAN module 113, short range communication module 115, location calculation module 117, and broadcasting reception module 119.

The mobile communication module 111 transmits and receives a wireless signal to and from at least one of a base station, an external device, and a server in the mobile communication network 400. The wireless signal includes various forms of data according to transmission and reception of an audio dedicated communication signal, audiovisual communication signal, or character/multimedia message. Particularly, the mobile communication module 111 connects to the mobile EMR management server 200 through a wireless network (e.g., the mobile communication network 400) and transmits a command according to information storage and information search to the mobile EMR management server 200. The mobile communication module 111 receives EMR information that the mobile EMR management server 200 transmits through a wireless network (e.g., the mobile communication network 400.

The wireless LAN module 113 performs wireless Internet access and forms a wireless LAN link with another client (e.g., a mobile EMR management server 200 or another mobile client) and can be housed within the mobile client 100 or coupled to the outside of the mobile client 100. Wireless Internet technology can include WLAN (Wi-Fi), wireless broadband (Wibro), world interoperability for microwave access (Wimax), and high speed downlink packet access (HSDPA). Particularly, the wireless LAN module 113 is connected to the mobile EMR management server 200 through a wireless network (e.g., the WLAN 500) to transmit the above command and to receive EMR information.

The short range communication module 115 is a module for short range communication. Short range communication technology can include Bluetooth, radio frequency identification (RFID), infrared data association (IrDA), ultra wideband (UWB), ZigBee, and near field communication (NFC).

The location calculation module 117 acquires a location of the mobile client 100, and a typical example thereof is a global position system (GPS) module. The location calculation module 117 calculates distance information separated from three or more base stations and accurate time information, applies trigonometry to the calculated information, and thus calculates three-dimensional present location information according to a latitude, longitude, and altitude. Alternatively, the location calculation module 117 calculates location information by continuously receiving, in real time, a present location of a mobile client from three or more satellites. Location information of the mobile client can be acquired by various methods.

The broadcasting reception module 119 receives a broadcasting signal (e.g., TV broadcasting signal, radio broadcasting signal, or data broadcasting signal) from an external broadcasting management server through a broadcasting channel (e.g., satellite channel, or terrestrial channel) and/or information related to the broadcasting (e.g., information related to a broadcasting channel, broadcasting program, or broadcasting service provider).

The user input unit 120 is used when the user inputs data for operation control of the mobile client 100. The user input unit 120 can include a keypad, dome switch, touch pad (capacitive/resistive), jog wheel, and jog switch.

The display unit 130 displays (outputs) information processed in the mobile client 100. For example, when the mobile client 100 is in a communication mode, the display unit 130 displays an UI or a GUI related to communication. Further, when the mobile client 100 is in an audiovisual communication mode or a photographing mode, the display unit 130 displays a photographed and/or received image, UI, or GUI. Particularly, the display unit 130 displays an UI or a GUI related to EMR information collected from the inside or the outside. A screen configuration and an operation illustration of the display unit 130 operated in the embodiments of the present disclosure will be described later.

Further, when the display unit 130 displays the UI or GUI, the display unit 130 supports a screen display in a horizontal mode and a screen display in a vertical mode according to a rotation direction (located direction) of the mobile client 100, and an adaptive screen conversion display according to a change between a horizontal mode and a vertical mode.

The display unit 130 can include at least one of a liquid crystal display (LCD), thin film transistor-liquid crystal display (TFT LCD), light emitting diode (LED), organic LED (OLED), active matrix OLED (AMOLED), flexible display, bended display, and three-dimensional display (3D display). In order to enable the user to view the outside, some displays can be embodied in a transparent display or a light transmitting display.

In the embodiments of the present disclosure, when the display unit 130 and a touch panel that senses a touch action form a mutual layer structure (hereinafter, a ‘touch screen’), the display unit 130 can be used as an input device in addition to an output device. The touch panel can be formed to convert a change of a pressure applied to a specific portion of the display unit 130 or a capacitance generating in a specific portion of the display unit 130 to an electrical input signal. The touch panel can be formed to detect a touch pressure as well as a touched position and area. When a touch input occurs at the touch panel, a signal corresponding to the touch input is output to a touch controller (not shown). The touch controller processes the signal and outputs corresponding data to the controller 170. Thereby, the controller 170 ascertains a touch area of the display unit 130.

The audio processor 140 performs a function of outputting an audio signal received from the controller 170 to a speaker 141 and outputting an audio signal such as a voice received from a microphone 143 to the controller 170. The audio processor 140 converts and outputs voice/sound data to an audible sound through the speaker 141 and converts an audio signal such as a voice received from the microphone 143 to a digital signal and outputs the digital signal to the controller 170 according to the control of the controller 170.

The speaker 141 outputs audio data received from the wireless communication unit 110 or stored at the storage unit 150 in a communication mode, record mode, speech recognition mode, and broadcasting reception mode. The speaker 141 outputs a sound signal related to a function (e.g., communication signal reception sound, message reception sound, music content reproduction, or EMR information reproduction) performed in the mobile client 100.

The microphone 143 receives an input of an external sound signal in a communication mode, record mode, and speech recognition mode to process the external sound signal into electrical voice data. In a communication mode, processed voice data is converted and output in a form that can be transmitted to a mobile communication base station through the mobile communication module 111. In the microphone 143, various noise removal algorithms for removing noise generated in a process of receiving an input of an external sound signal can be included.

The storage unit 150 stores a program for a processing and a control of the controller 170 and performs a function for temporarily storing input/output data (e.g., phonebook, message, audio, still picture, e-book, moving picture, log information, or EMR information). The storage unit 150 can together store the use frequency (e.g., use frequency of each phone number, each message, each multimedia, or each EMR information) and importance of each of the data. Further, the storage unit 150 stores data about various patterns of vibrations and sounds that are output when a touch input occurs on a touch screen. The storage unit 150 includes at least one storage medium of a flash memory type, hard disk type, micro type, and card type memory (e.g., SD or XD memory), and random access memory (RAM), static RAM (SRAM), read-only memory (ROM), electrically erasable programmable ROM (EEPROM), programmable ROM (PROM), magnetic RAM (MRAM), magnetic disk, and optical disk type memory. A mobile client 100 can operate a function related to web storage, such as performing a storage function of the storage unit 150 on Internet.

The interface unit 160 performs a passage function of entire external devices connected to the mobile client 100. The interface unit 160 receives transmission of data or receives supply of power from an external device to output data or power to each constituent element within the mobile client 100. The interface unit 160 enables each constituent element within the mobile client 100 to transmit data to an external device. For example, a wired/wireless headset port, external charger port, wired/wireless data port, memory card port, port for connecting a device having an identity module, audio input/output (I/O) port, video I/O port, and earphone port can be included in the interface unit 160.

The controller 170 controls general operations of the mobile client 100. For example, the controller 170 performs a control and a processing related to audio dedicated communication, data communication, and audiovisual communication. The controller 170 includes a multimedia module (not shown) for reproducing multimedia. The multimedia module can be formed within the controller 170 or can be formed separately from the controller 170. Particularly, the controller 170 controls general operations related to storage of information by interlocking with the mobile EMR management server 200 at the HIS 300 and a search and an output of the information stored at the HIS 300. The controller 170 controls a series of operations of receiving information provided from the mobile EMR management server 200 and outputting the information to the display unit 130 through a preset UI or GUI.

The power supply unit 180 receives external power and internal power by the control of the controller 170 and supplies power necessary for operation of each of constituent elements.

Various embodiments described in the present disclosure can be embodied within a recording medium that can be read by a computer or a similar device using software, hardware, or a combination thereof. When embodied with hardware, embodiments described in the present disclosure can be embodied using at least one of electrical unit for application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and an electric unit for performing other functions. In some cases, embodiments described in this specification can be embodied by the controller 170 itself. When embodied with software, embodiments like a procedure and a function described in this specification can be embodied with separate software modules. Each of the software modules can perform at least one function and operation described in this specification.

The mobile client 100 of the present disclosure, shown in FIG. 2, includes entire devices using an application processor (AP), a graphic processing unit (GPU), and central processing unit (CPU) like information and communication devices, multimedia devices, and application devices thereof that support a function of the embodiments of the present disclosure. For example, the mobile client can include a device such as a tablet personal computer (PC), smart phone, portable multimedia player (PMP), media player, and personal digital assistant (PDA) as well as a mobile communication terminal operating based on each communication protocol corresponding to various communication systems. Further, a method of controlling a function of the embodiments present disclosure can be applied to various display devices such as a digital television, digital signage (DS), and a large format display (LFD) and can be executed.

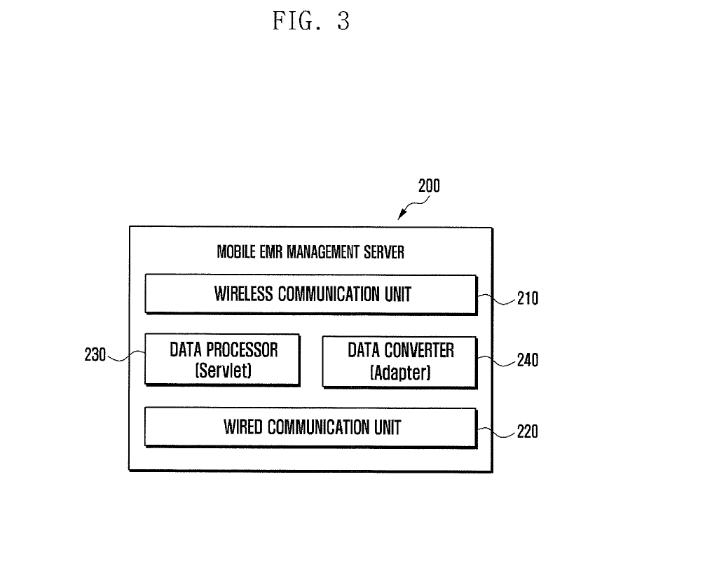

FIG. 3 illustrates a configuration of a mobile EMR management server 200 of FIG. 1.

Referring to FIG. 3, the mobile EMR management server 200 of the present disclosure includes a wireless communication unit 210, wired communication unit 220, data processor 230, and data converter 240. The mobile EMR management server 200 of the present disclosure includes constituent elements more than or less than those shown in FIG. 3.

The wireless communication unit 210 includes at least one module for enabling receipt of a command from the mobile client 100 and to transmit EMR information. For example, the wireless communication unit 210 is connected to the mobile client 100 through a wireless network by a mobile communication module or a wireless LAN module to perform data communication.

The wired communication unit 220 includes at least one module for enabling transmission of a command to the HIS 300 and receipt of EMR information from the HIS 300. For example, the wired communication unit 220 is connected to the HIS 300 through the wired network 600 (e.g., local area network (LAN), wide area network (WAN), or public switched telephone network (PSTN)) to perform data communication.

The data processor 230 analyzes a command (received command) of the mobile client 100 received through the wireless communication unit 210 and analyzes a command of the HIS 300 corresponding to the received command. The data processor 230 manages wired data communication to forward a specification command converted in the data converter 240 to the HIS 300 through the wired communication unit 220. Further, when the data processor 230 acquires information corresponding to a command from the HIS 300, the data processor 230 manages wireless data communication to transmit the information to the mobile client 100 through the wireless communication unit 210. In certain embodiments of the present disclosure, the data processor 230 is embodied in a servlet. The servlet is a small-sized program that executes in the mobile EMR management server 200 and supports data communication (e.g., HTTP communication) of a data interface specification agreed-upon with the mobile client 100.

The data converter 240 converts a received command to a command (specification command) of a data interface specification agreed-upon with the HIS 300 with reference to a command of the HIS 300 analyzed through the data processor 230. That is, the data converter 240 converts a received command to an authenticated command for data communication with the HIS 300. In embodiments of the present disclosure, the data converter 230 performs an adaptor function. Particularly, the data converter 240 converts a command forwarded through the data processor 230 to be interlocked by an adaptor according to a method in which the HIS 300 supports. For example, the data converter 240 converts a received command based on an adaptor corresponding to a method supported by the HIS 300 connected to the mobile EMR management server 200 among various adaptors such as a service advertising protocol (SAP), WEB, HL7, java database connectivity (JDBC), and VO/DAO ((extensible markup language) XML).

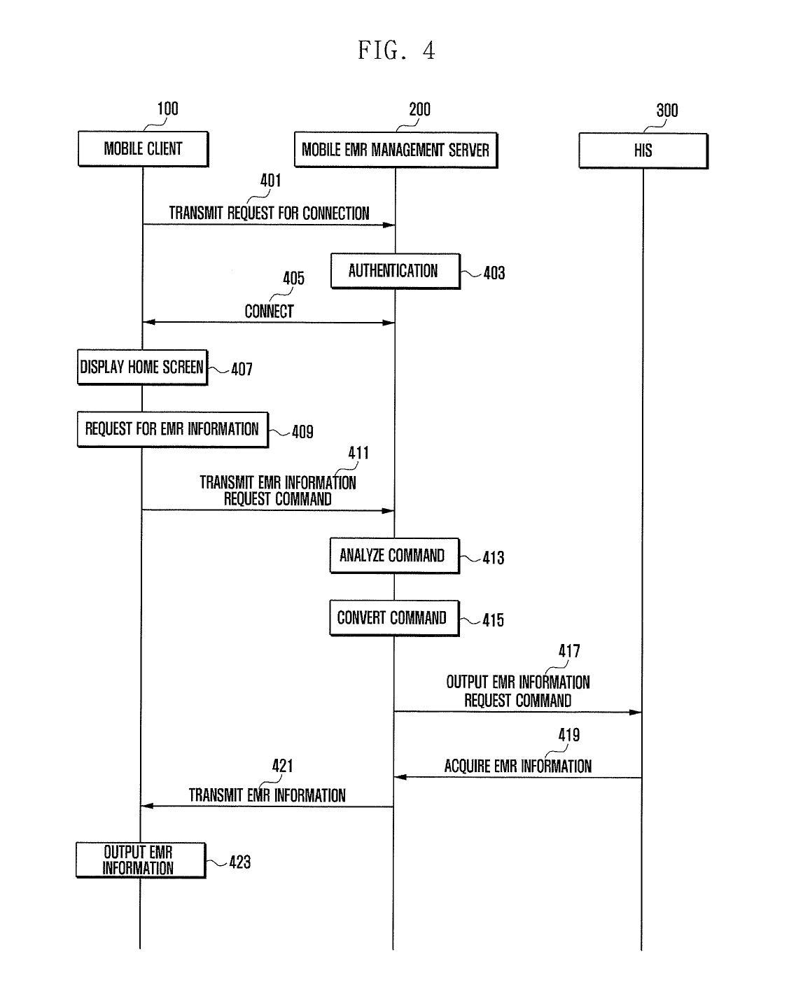

FIG. 4 is a message flow diagram illustrating a service operation of the mobile EMR system of FIG. 1.

Referring to FIG. 4, the mobile client 100 transmits a request for connection to the mobile EMR management server 200 in response to a user request (401). For example, the user executes an EMR application using the mobile client 100, inputs user authentication information (e.g., identity (ID), or password), and performs a log-in procedure. Therefore, the mobile client 100 transmits identification information of the mobile client 100 and user authentication information input by the user to the mobile EMR management server 200.

When a request for connection is received from the mobile client 100, the mobile EMR management server 200 performs an authentication procedure of the mobile client 100 (403). That is, the mobile EMR management server 200 determines whether the mobile client 100 that requests connection is a previously defined and authenticated mobile client and is an authenticated user. When the mobile client 100 is normally authenticated by the mobile EMR management server 200, the mobile client 100 is connected to the mobile EMR management server 200 (405).

When the mobile client 100 is connected to the mobile EMR management server 200, the mobile client 100 displays a given UI or GUI-based home screen through the display unit 130 (407). A screen provided in the mobile client 100 will be illustrated later.

When a request for EMR information is input by the user (409), the mobile client 100 generates an EMR information request command and transmits the EMR information request command to the mobile EMR management server 200 (411). For example, in order to determine EMR information in which the user wants on a home screen of the mobile client 100, the user may input a manipulation that requests a search for the corresponding EMR information. As a result, the mobile client 100 generates a corresponding command in response to the EMR information request and transmits the command through the mobile EMR management server 200 and a formed network (e.g., mobile communication network or wireless LAN).

When the mobile EMR management server 200 receives an EMR information request command from the mobile client 100 connected thereto, the mobile EMR management server 200 analyzes the received command (413) and converts the received command to a command of a specification agreed-upon with the HIS 300 (415). For example, the mobile EMR management server 200 converts the received command to a specification command of an agreed-upon data interface specification that can call EMR information by accessing a database of the HIS 300. That is, as described above, the mobile EMR management server 200 converts a received command to be interlocked by various adaptors according to a method in which the HIS 300 supports.

The mobile EMR management server 200 forwards an EMR information request command of the mobile client 100 to the HIS 300 using a converted specification command (417) and acquires EMR information corresponding to a specification command from the HIS 300 (419).

The mobile EMR management server 200 transmits the EMR information acquired from the HIS 300 to the mobile client 100 through the mobile client 100 and the formed network (421).

The mobile client 100 receives EMR information corresponding to an EMR information request command from the mobile EMR management server 200 and outputs the received EMR information according to a given UI or GUI through the display unit 130 (423). A screen provided in the mobile client 100 will be illustrated later.

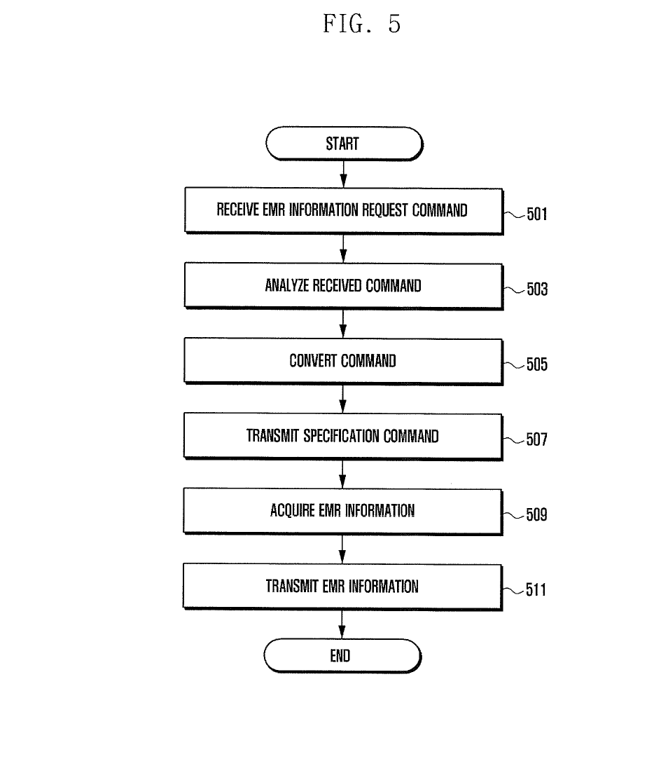

FIG. 5 illustrates operation of processing a command in the EMR management server of FIG. 1.

Referring to FIG. 5, the mobile EMR management server 200 receives an EMR information request command from the mobile client 100 (501). In this case, when the mobile EMR management server 200 receives an EMR information request command from the mobile client 100, the mobile EMR management server 200 determines whether the mobile client 100, having transmitted the EMR information request command is connected to the mobile EMR management server 200 and is an authenticated mobile client.

If the mobile client 100 is an authenticated mobile client, the mobile EMR management server 200 performs the following operation, and if the mobile client 100 is not an authenticated mobile client, the mobile EMR management server 200 ignores the request or performs and operation of forwarding a warning and requesting a registration.

The mobile EMR management server 200 analyzes a received command received from the mobile client 100 (503). For example, the mobile EMR management server 200 analyzes a type of the received command to determine whether EMR information according to the received command requests access to which EMR information among the EMR information such as patient information, prescription, problem history, test result, and schedule.

The mobile EMR management server 200 converts the received command to a previously agreed-upon data interface specification of specification command according to an analyzed result (505) and transmits the converted specification command to the HIS 300 (507). For example, when it is assumed that a data interface specification is an XML interface, the mobile EMR management server 200 converts a received command received in a HTTP interface specification for a database query of the HIS 300 to an XML interface specification. For example, when the user requests EMR information about a schedule using the mobile client 100, a schedule EMR information request command can be received in a HTTP specification to the mobile EMR management server 200. Therefore, for a query of schedule EMR information, the mobile EMR management server 200 converts a command of the HTTP specification to a command of an XML specification in which the HIS 300 supports and forwards the command to the HIS 300, thereby calling schedule EMR information.

When the mobile EMR management server 200 acquires EMR information corresponding to the specification command (509), the mobile EMR management server 200 transmits the acquired EMR information to the mobile client 100 (511).

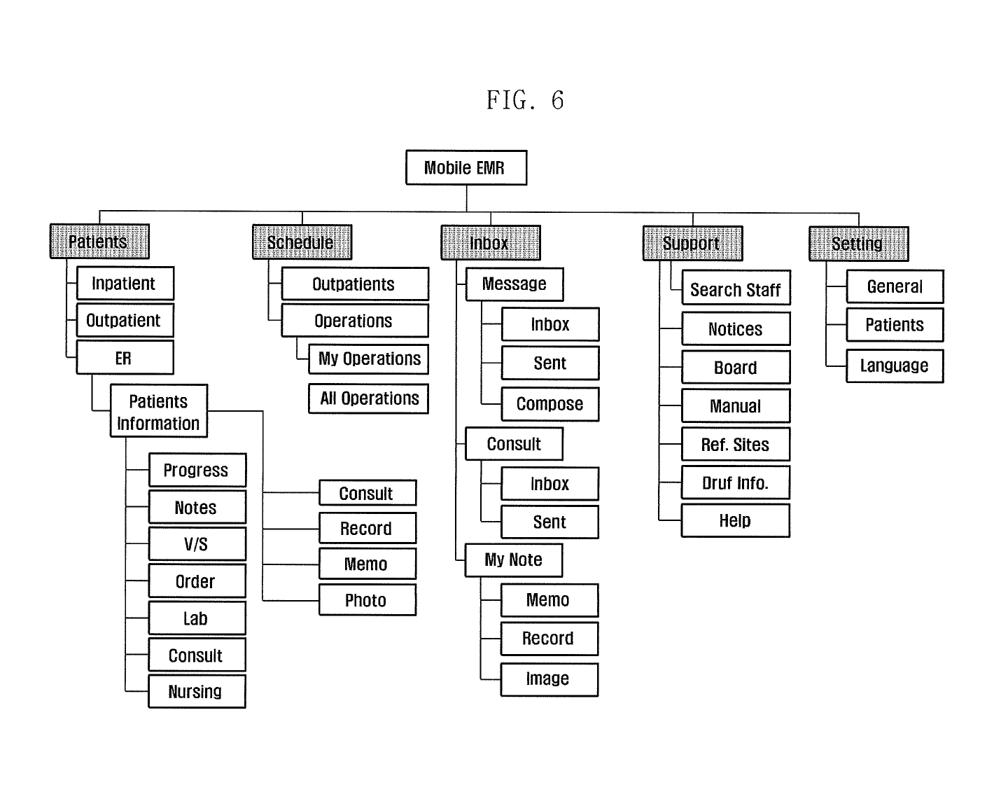

FIG. 6 illustrates a support function in the mobile EMR system of FIG. 1.

Referring to FIG. 6, in the mobile EMR system of the present disclosure, information related to patients, information related to a schedule, transmission and reception information of a message, and various information can be determined in real time without a temporal and spatial restriction through a mobile client. As a function supported through the mobile EMR system of the present disclosure, a patient function of reading and recording a record related to a patient, a schedule function of reading and recording a schedule of the user (e.g., medical team or patient), an inbox function of interchanging and sharing real time information of the user, a support function of reading and recording a common additional material, and a setting function of forming a screen interface or setting information to correspond to the user (e.g., doctor, nurse) can be provided. By subdividing the main function, more detailed function contents can be provided.

Therefore, in the mobile EMR system of the present disclosure, the user (e.g. medical team) may determine a patient's basis information, vital sign, prescription particulars, test result, and nursing record at any time and place using the mobile client 100 through the patients function and may leave a visit record through a picture, memo, and record. Further, the user may determine an outpatient medical treatment schedule and a surgical operation schedule recorded in a hospital information system using the mobile client 100 through the schedule function. Further, medical teams, nurses, and medical staff can transmit and receive a note in real time through the inbox function, and when a consult is requested, medical teams, nurses, and medical staff can immediately determine and respond to several situations through the mobile EMR system without moving to a fixed location at which a PC is installed. The user (e.g., medical team) may search and determine in real time various information and functions such as staff search, bulletin board determination, medical site search, and medicine information together with a tool that can read various medical reference materials through the support function.

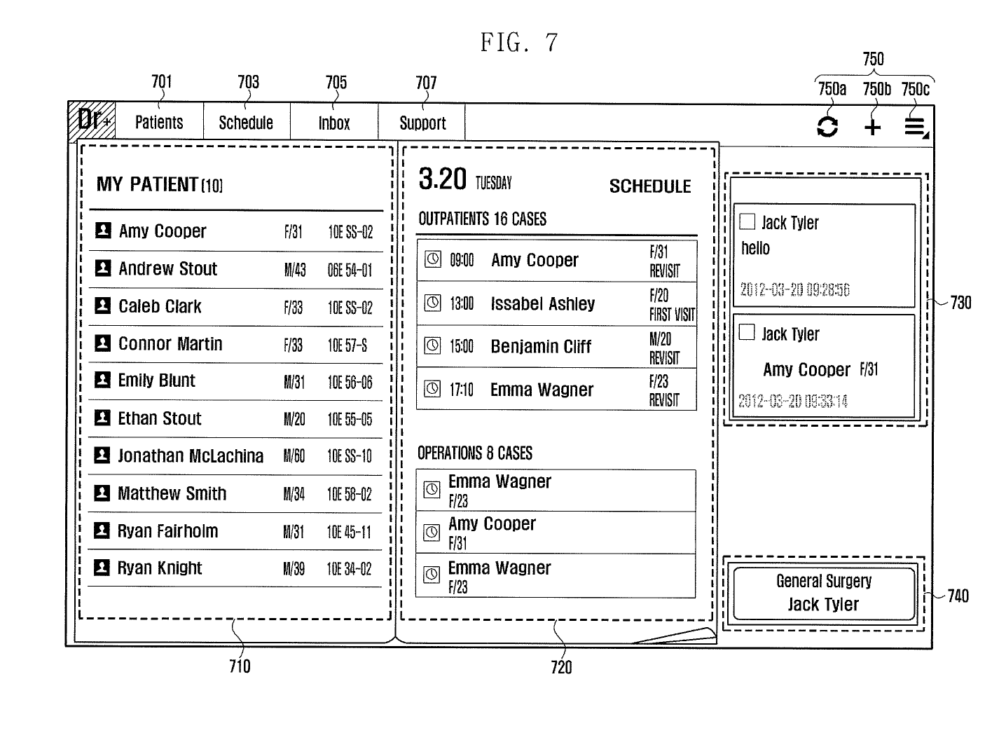

FIGS. 7 to 16 illustrate a screen interface supported through the mobile EMR system of FIG. 1. Particularly, FIGS. 7 to 16 illustrate a screen interface provided through the mobile client 100 of the present disclosure, and such a screen interface can be provided by interlocking between the mobile client 100, the mobile EMR management server 200, and the HIS 300.

FIG. 7 illustrates a home screen of the mobile client 100. That is, FIG. 7 illustrates a screen interface of a home screen provided when the user accesses the mobile EMR management server 200 through the mobile client 100. The home screen includes an inpatient list area 710, outpatient medical treatment and surgical operation schedule area 720, and charge doctor information area 740. In an upper end portion of the screen, a patients menu 701, schedule menu 703, inbox menu 705, and support menu 707, which are menus that can immediately execute main functions supported through the mobile EMR system are provided. In an upper end portion of the right side of the screen, a refresh button 750a, add button 750b, and more view button 750c, are shortcut buttons 750 for executing other additional functions are provided. That is, the home screen can be formed with a summary screen in which the user can determine intuitively at one time major information of entire functions that can use through the mobile EMR system, and such a summary screen can be variously formed with different kinds of menus and information according to user setting.

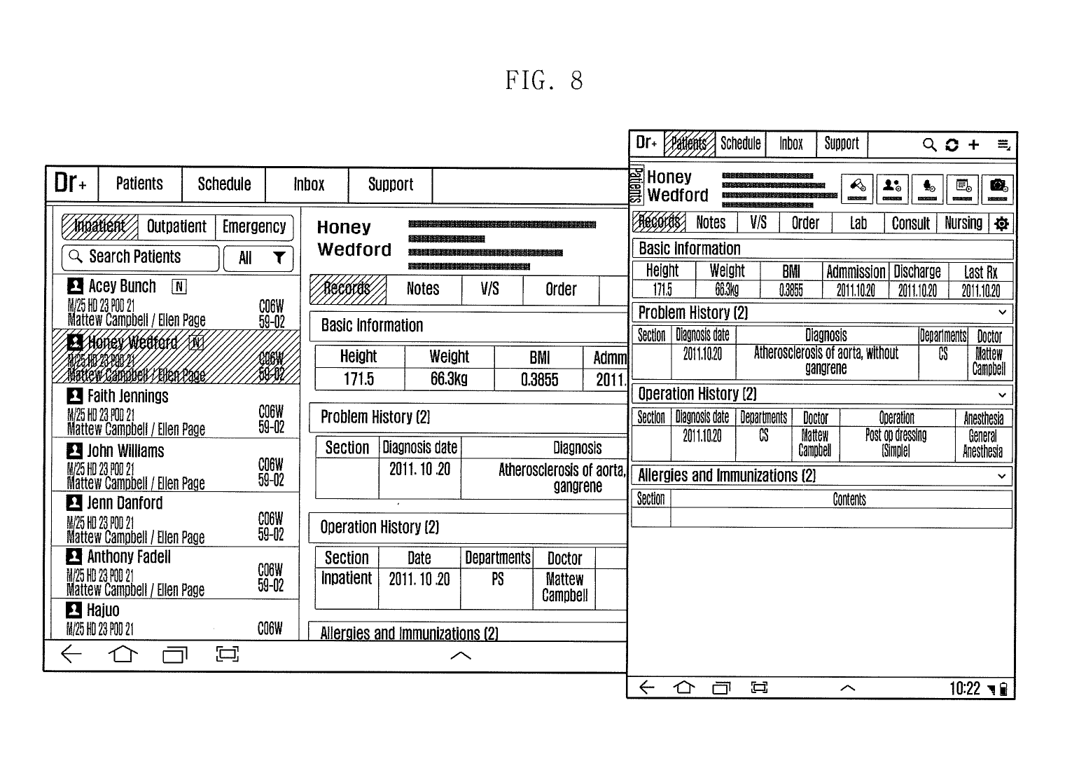

When the user is normally authenticated using the mobile client 100 according to the above-described log-in procedure, the home screen shown in FIG. 7 can be provided. The user may move from the home screen to a desired screen by selecting (e.g., tab selection) a menu of a desired function. For example, when the user selects the patients menu 701 on the home screen of FIG. 7, a screen of the mobile client 100 changes, as shown in FIG. 8.

FIG. 8 illustrates a screen of the mobile client 100 of a case where the patients menu 701 is selected from the function menu.

That is, FIG. 8 illustrates a screen of an UI or a GUI provided to the mobile client 100 when the user selects the patients menu 701, and the home screen of FIG. 7 can be formed and displayed in various information related to a patient. As shown in FIG. 8, a patient basic record can be read through the patients menu 701. For example, various information such as a problem history, surgical operation history, and allergy information as well as basic information such as a patient's height and weight can be provided. As shown in FIG. 8, various screen interfaces provided in the present disclosure can be converted and provided to a horizontal mode or a vertical mode according to a rotation direction of the mobile client 100.

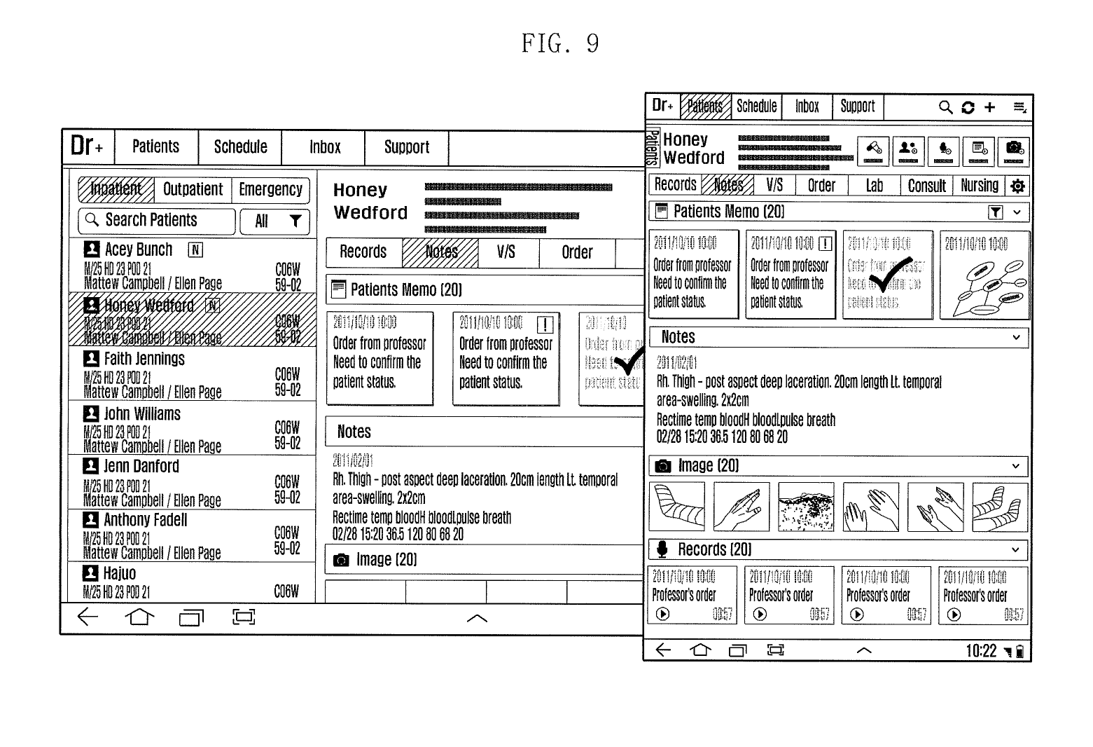

The user may select a patients menu on a screen of FIG. 8. For example, the user may select a “notes” tab on the screen of FIG. 8. Therefore, the mobile client 100 displays a screen of FIG. 9 according to the user's selection on the “notes” tab. That is, the screen of the mobile client 100 shown in FIG. 8 changes to a menu corresponding to a selected screen of FIG. 9 according to the user's selection on a sub-menu.

FIG. 9 illustrates a screen of the mobile client 100 when the user selects a “notes” menu provided to a sub-menu of the patients menu 701.

As shown in FIG. 9, the user may determine a memo about a patient, voice record, and data in which a picture is photographed through a patient note menu, and the user may directly generate and store the information using the mobile client 100.

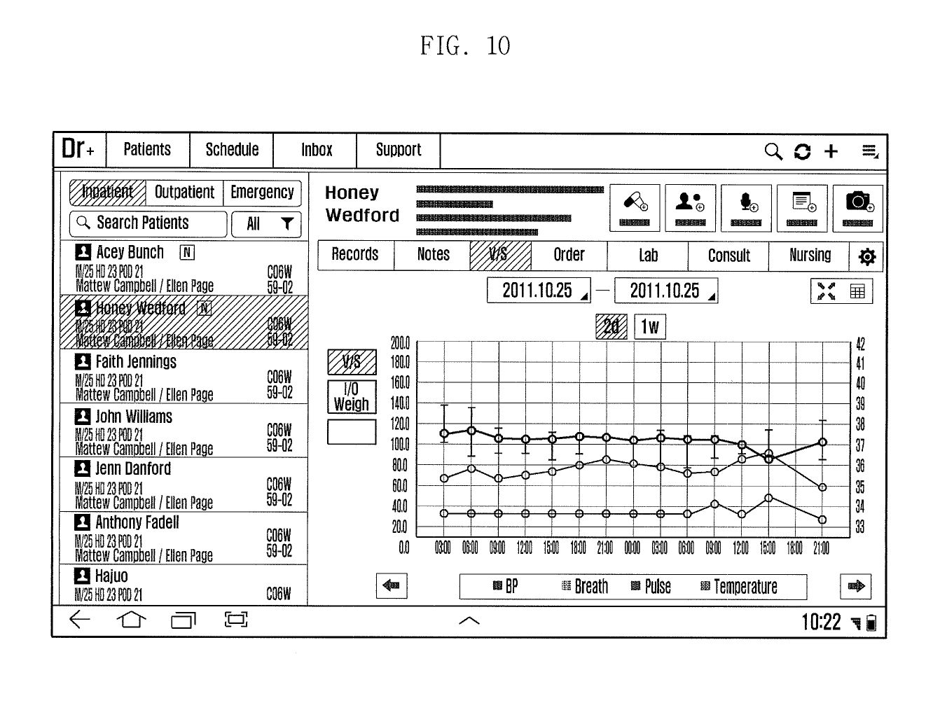

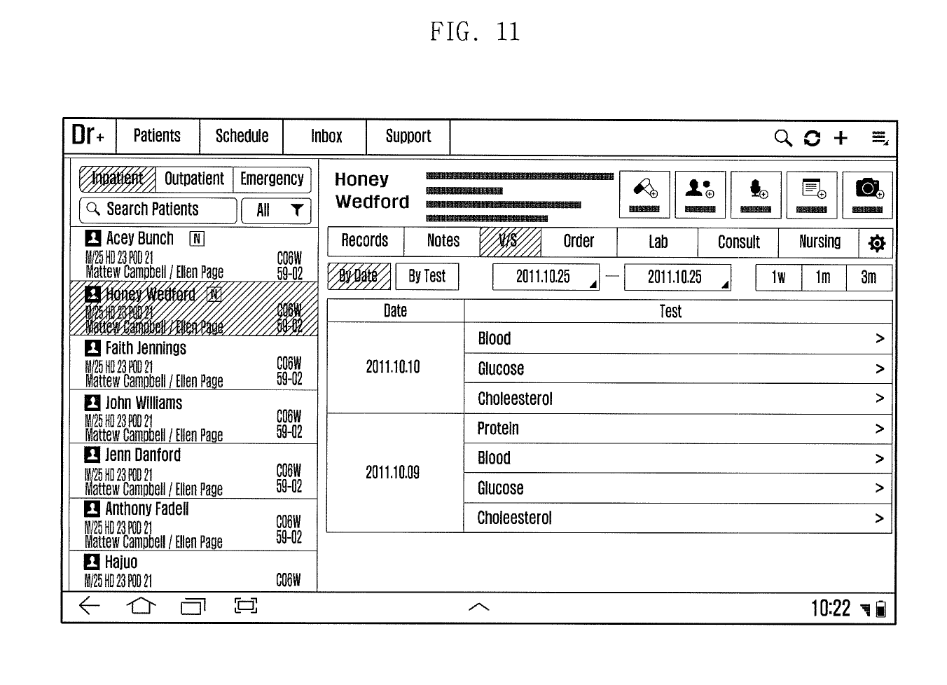

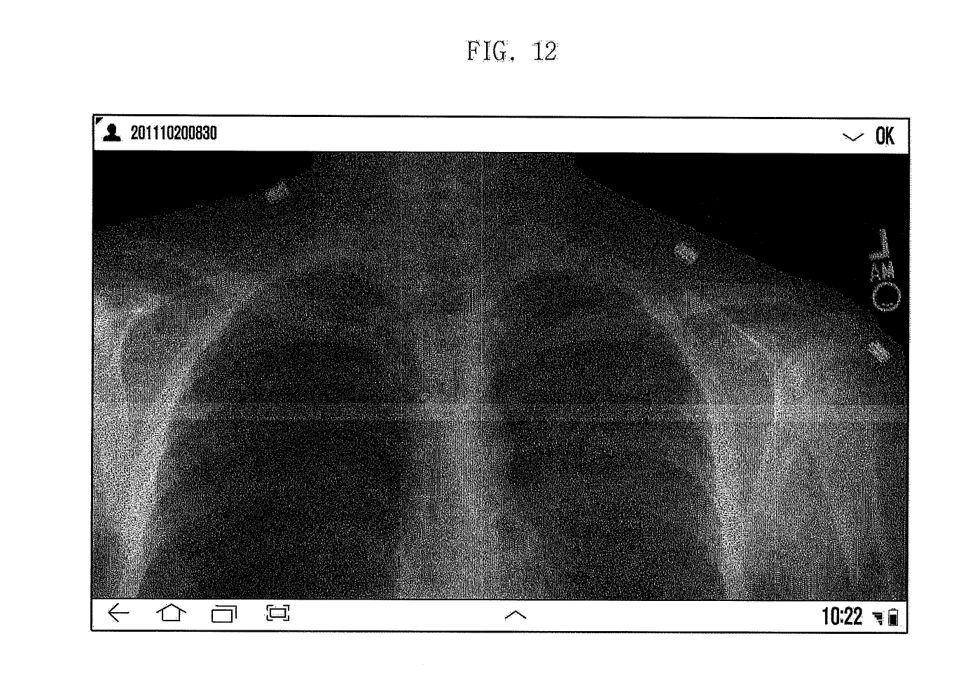

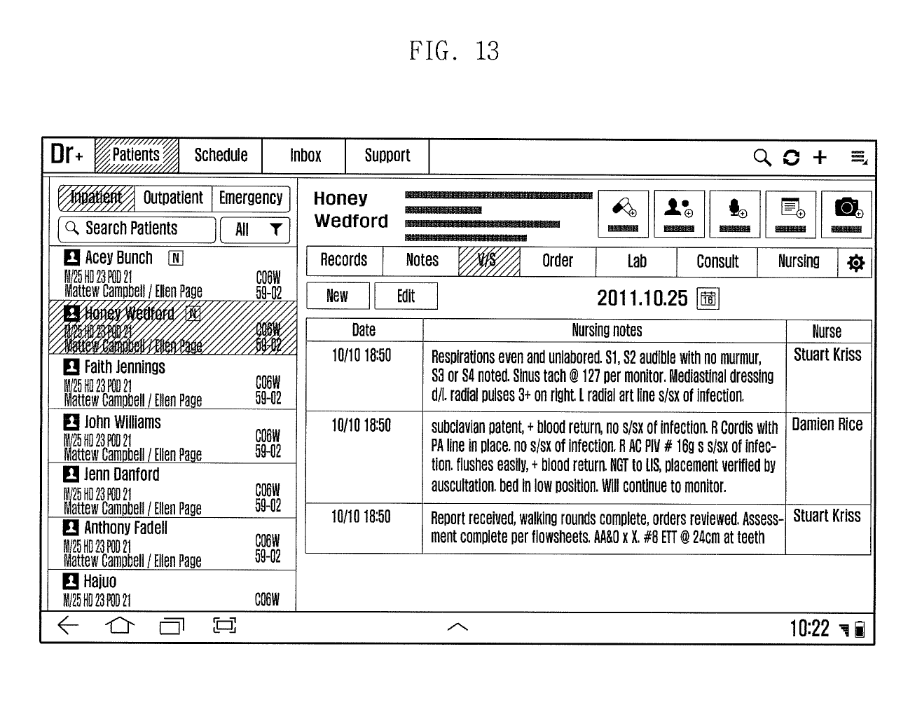

The user may read various EMR information or record new EMR information by selecting various menus through the operation. For example, as shown in FIG. 10, the user can intuitively determine a vital sign of a patient through a table and a graph of a menu “V/S” or can determine or record 10 (input & output, a difference between an input such as injection or meal and an output such as urine or excrements) through a menu “V/S”. Further, as shown in FIG. 11, a test result about a patient can be determined through a “lab” menu, and when detailed contents of a test result are selected, a table and a graph corresponding to a test kind and a PACS image shown in FIG. 12 can be automatically provided. Further, as shown in FIG. 13, a nursing record about a patient can be determined or directly recorded through a “nursing” menu, and in addition, a function of determining and sharing a consult record about a patient can be provided.

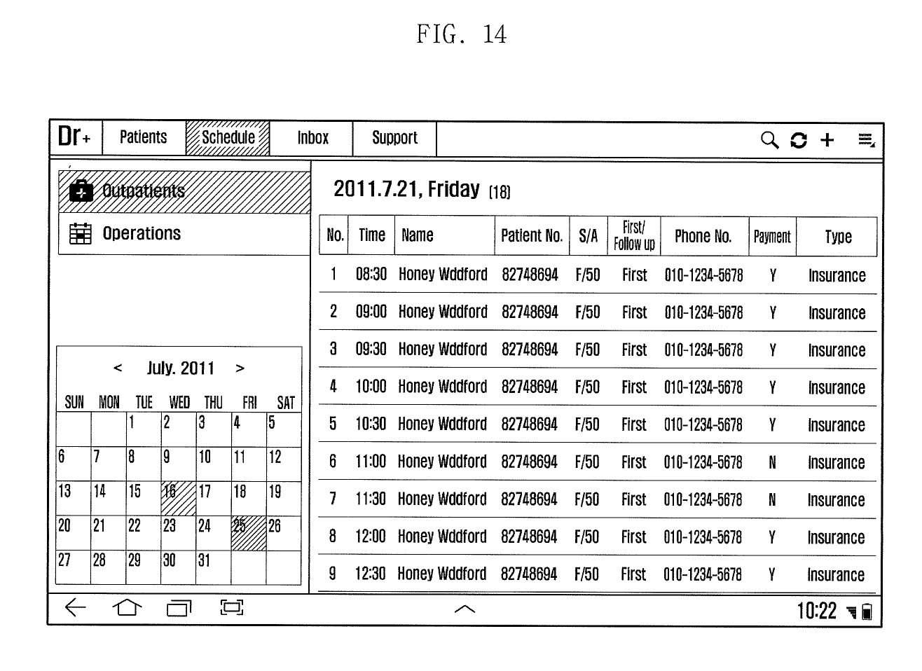

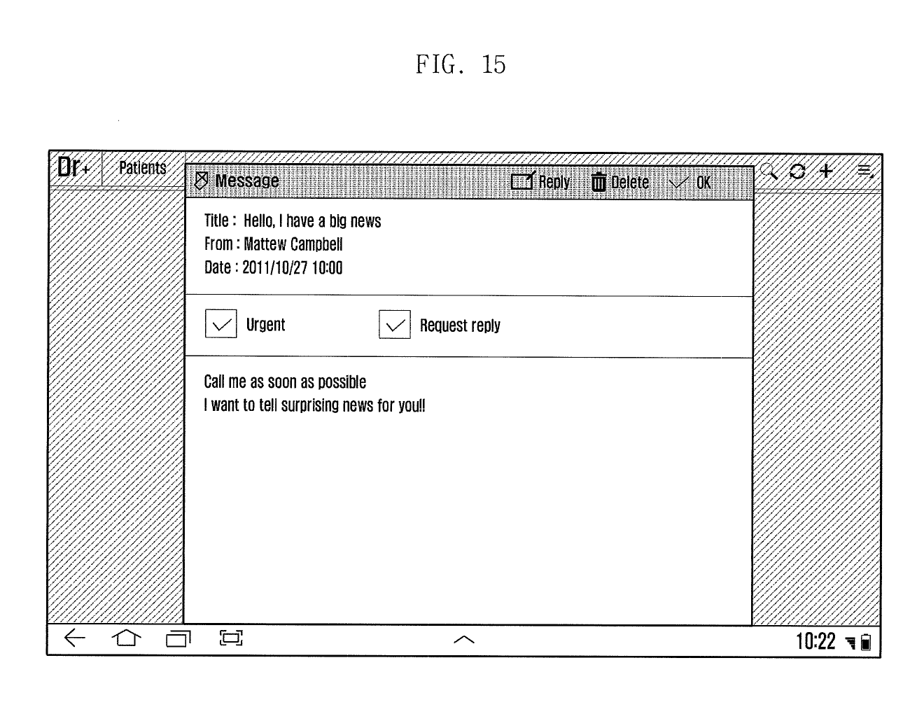

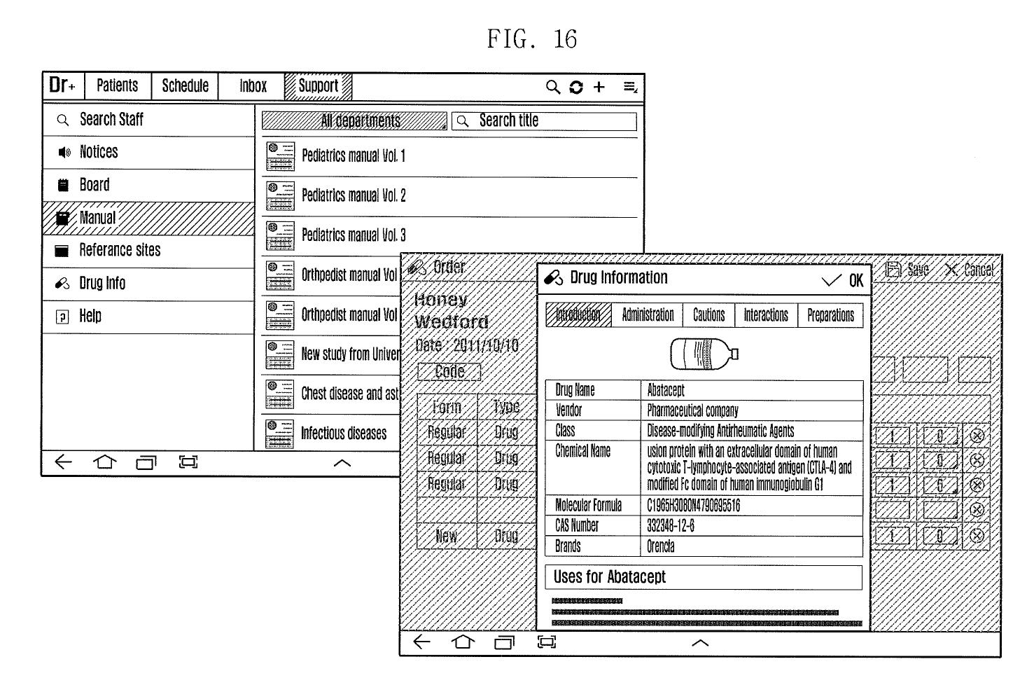

Further, as shown in FIG. 14, the user may determine various schedules such as an outpatient medical treatment schedule and a surgical operation schedule according to a date using the schedule menu 703. Further, as shown in FIG. 15, the user may give and receive a general message and a consult request to and from another user using the inbox menu 705 and can record and store a private record registration memo, voice record, and a picture form. Further, as shown in FIG. 16, the user may use an additional function such as a staff search, announcement determination, medical treatment related manual determination, connection through a medical treatment related information web site link, and medical information through the support menu 707.

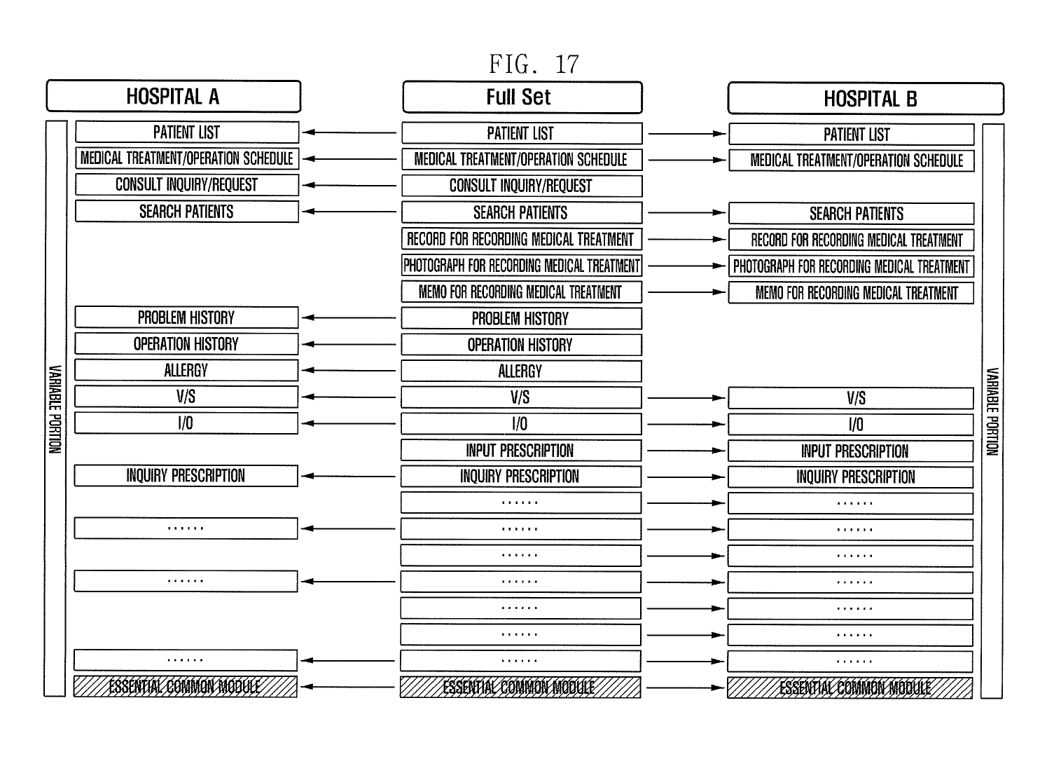

FIG. 17 is a diagram illustrating a concept of the mobile EMR system of FIG. 1.

Referring to FIG. 17, the mobile EMR system according to embodiments of the present disclosure selects only necessary portions from a full set of synthesized functions of a general EMR and be formed in a form appropriate to a characteristic of each hospital.

For example, the mobile EMR system of the present disclosure can have entire functions of a patient list, medical treatment/surgical operation schedule, consult inquiry/request, patient search, record for recording a medical treatment, photograph for recording a medical treatment, memo for recording a medical treatment, problem history, surgical operation history, allergy, V/S, I/O, prescription input, and prescription inquiry through the mobile EMR management server 200. By selectively activating only some functions of the entire functions like an illustration of a hospital A and a hospital B of FIG. 17 according to request contents of each hospital, a mobile EMR system can be provided. That is, according to the mobile EMR system of the present disclosure, while maintaining an existing EMR in which each hospital uses by a fabricated method or a method using a gateway in entire synthesized functions of an EMR, by reflecting only contents in which a hospital requests, a mobile EMR system can be simply embodied.

As described above, embodiments of the present disclosure be embodied in a program command form that is performed through various computer means and be recorded in a computer readable recording medium. The computer readable recording medium can include individual or a combination of program command, data file, and data structure. A program command recorded in the recording medium can be specially designed and formed for the present disclosure or can be already known to a person of ordinary skill in the computer software art and be used.

The computer readable recording medium includes a hardware device specially formed to store and perform a program command such as magnetic media such as a hard-disk, a floppy disk, and a magnetic tape, optical media such as a compact disc read only memory (CD-ROM) and a digital versatile disc (DVD), magneto-optical media such as an optical disk, read only memory (ROM), random access memory (RAM), and flash memory. Further, a program command includes a high-level language code that can be executed by a computer using an interpreter as well as a machine language code made by a compiler. In order to perform operation of the present disclosure, the above-described hardware device can be formed to operate as at least one software module and vice versa.

As described above, according to an EMR system and a method of providing a service thereof suggested in the present disclosure, a PC-based EMR can be simply replaced to a mobile client-based EMR. Portability, mobility, and usability of a user can be improved through a mobile EMR system of the present disclosure and thus an input, edition, and general hospital work as well as an inquiry about a patient can be performed in real time without temporal and spatial restriction.

Further, by providing a systematic interface between a mobile client, mobile EMR management server, and HIS for embodying a mobile EMR system, an efficient integrated medical management can be provided. Thereby, as the user can use a mobile client with a usually used method for the same or similar function in different EMR systems of each hospital, inconvenience in using different EMR systems of each hospital can be removed.

Further, by enabling a hospital attempting to construct a mobile EMR system to easily configure the mobile EMR system by combining only a specified function, the mobile EMR system can be quickly constructed.

Therefore, according to the present disclosure, by embodying an optimal environment for embodying a mobile EMR system, user convenience is improved, and EMR accessibility by a mobile client, convenience, and competitive power can be improved. A mobile EMR system according to the present disclosure can be simply embodied to entire forms of mobile clients and various devices corresponding thereto.

Although the present disclosure has been described with an example, various changes and modifications may be suggested to one skilled in the art. It is intended that the present disclosure encompass such changes and modifications as fall within the scope of the appended claims.

What is claimed is:

1. A method of providing a service in a mobile electronic medical record (EMR) system, the method comprising:
receiving, by a mobile EMR management server, a command that requests EMR information from a mobile client;
converting the received command to a command of a method in which a hospital information system (HIS) supports;
forwarding an EMR information request to the HIS using the converted command;
acquiring the requested EMR information from the HIS; and
transmitting the acquired EMR information to the mobile client.

2. The method of claim 1, wherein converting the command to a command of a method the HIS supports comprises: converting the received command to a command of a data interface specification configured to call the EMR information by accessing a database of the HIS.

3. The method of claim 2, wherein converting the command to a command of a method the HIS supports comprises: converting, by the mobile EMR management server, the received command to be interlocked by an adaptor corresponding to a method the HIS supports.

4. The method of claim 2, wherein converting the command to a command of a method the HIS supports further comprises:
transmitting, by the mobile client, an EMR information request command of a hyper text transfer protocol (HTTP) interface specification to the mobile EMR management server for a database query of the HIS;
receiving, by the mobile EMR management server, the command of the HTTP interface specification; and
converting, by the mobile EMR management server, the received command to a command of an extensible markup language (XML) interface specification the HIS supports.

5. The method of claim 2, further comprising determining, by the mobile EMR management server, when an EMR information request command is received from the mobile client, whether the mobile client that transmitted the EMR information request command is an authenticated mobile client.

6. The method of claim 1, further comprising:
requesting, by the mobile client, access to the mobile EMR management server in response to a user request;
authenticating, by the mobile EMR management server, the mobile client;
connecting the mobile client and the mobile EMR management server;
displaying, when the mobile client is connected to the mobile EMR management server, a preset home screen; and
acquiring and displaying, by the mobile client, EMR information of the HIS through the mobile EMR management server to correspond to a user input.

7. A mobile EMR system, comprising:
a mobile client configured to execute a client program for an EMR information service and to transmit an EMR information request command corresponding to a user input;
a mobile EMR management server configured to:
convert a command, received from the mobile client, to a command of an interface specification a hospital information system (HIS) supports,
acquire EMR information based on the converted command, and
forward the EMR information to the mobile client; and
the HIS configured to construct and store various EMR information into a database.

8. The mobile EMR system of claim 7, wherein the mobile EMR management server comprises commands configured to:
execute to receive a command that requests EMR information from the mobile client,
convert the command, received from the mobile client, to a command of a method in which the HIS supports,
forward an EMR information request to the HIS using the converted command,
acquire EMR information requested from the HIS, and
transmit the acquired EMR information to the mobile client.

9. The mobile EMR system of claim 8, wherein the mobile EMR management server converts the received command to a specification command of a data interface specification configured to call the EMR information by accessing a database of the HIS.

10. The mobile EMR system of claim 9, wherein the mobile EMR management server is configured to convert the received command to be interlocked by an adaptor corresponding to a method the HIS supports.

11. The mobile EMR system of claim 9, wherein the mobile EMR management server is configured to:
receive an EMR information request command of a HTTP interface specification for a database query of the HIS from the mobile client,
convert the received command to a command of an XML interface specification the HIS supports, and
forward the command to the HIS.

12. The mobile EMR system of claim 9, wherein the mobile EMR management server comprises:
a data processor configured to:
receive and analyze the EMR information request command of a HTTP interface specification the mobile client transmits and
distinguish a support command of the HIS corresponding to the EMR information request command; and
a data converter configured to convert and output the EMR information request command of the mobile client to a command of a method the HIS supports.

13. The mobile EMR system of claim 12, wherein the data processor comprises a servlet configured to support data communication according to the HTTP interface, and
the data converter comprises at least one adaptor configured to interlock with an interface of a method the HIS supports.

14. The mobile EMR system of claim 8, wherein in the mobile EMR system, the mobile client and the mobile EMR management server are separated from the HIS as an independent function module, and the mobile EMR management server is interlocked with the HIS by activating only a function allowed by the HIS.

15. A computer readable recording medium comprising a plurality of instructions, wherein at least portion of the plurality of instructions is configured to, when executed, cause a processor to provide a service of:
receiving a command that requests EMR information,
converting the received command to a command of a method a hospital information system (HIS) supports, and
acquiring and providing the requested EMR information to the HIS using the converted command.

16. The computer readable recording medium of claim 15, wherein the at least a portion of the plurality of instructions of the program configured to cause the processor to convert the received command to a command of a method the HIS supports further comprises:
converting the received command to a command of a data interface specification configured to call the EMR information by accessing a database of the HIS.

17. The computer readable recording medium of claim 16, wherein the at least a portion of the plurality of instructions of the program configured to cause the processor to convert the received command to a command of a method the HIS supports further comprises:
converting the received command to be interlocked by an adaptor corresponding to a method the HIS supports.

18. The computer readable recording medium of claim 16, wherein the at least a portion of the plurality of instructions of the program configured to cause the processor to:
receive an EMR information request command of a HTTP interface specification for a database query of the HIS from a mobile client,
convert the received command to a command of an XML interface specification the HIS supports, and
forward the command to the HIS.

19. The computer readable recording medium of claim 15, wherein the at least a portion of the plurality of instructions of the program is further configured to the processor to:
receive and analyze the EMR information request command of a HTTP interface specification the mobile client transmits;
distinguish a support command of the HIS corresponding to the EMR information request command; and
convert and output the EMR information request command of a mobile client to a command of a method the HIS supports.

20. The computer readable recording medium of claim 19, wherein the at least a portion of the plurality of instructions of the program is further configured to the processor to:
support data communication according to the HTTP interface, and
interlock with an interface of a method the HIS supports.
